(19) United States
(12) Patent Application Publication
(10) Pub. No.: US 2005/0198008 A1
(43) Pub. Date: Sep. 8, 2005

(54) Index exploitation for spatial data

(76) Inventor: David W. Adler, Mount Tremper, NY (US)

Correspondence Address: KONRAD RAYNES & VICTOR, LLP;ATTN: IBM54, 315 SOUTH BEVERLY DRIVE, SUITE 210, BEVERLY HILLS, CA, 90212, US

(21) Appl. No.: 10/792,446

(22) Filed: Mar. 2, 2004

(51) Int. Cl. G06F 17/30

(52) U.S. Cl. 707/3

(57) ABSTRACT

Provided is a technique for index exploitation. A spatial region query referencing a spatial region is received. The spatial region is divided into intervals. Search ranges are generated for each interval. An index scan is performed for each interval.

### BACKGROUND

1. Field

Implementations of the invention relate to index exploitation for spatial data.

2. Description of the Related Art

Databases are computerized information storage and retrieval systems. A Relational Database Management System (RDBMS) is a database management system (DBMS) that uses relational techniques for storing and retrieving data. Relational databases are organized into tables which consist of rows, all having the same columns of data. Each column maintains information on a particular type of data for the data records which comprise the rows. The rows are formally called tuples or records. A database will typically have many tables and each table will typically have multiple tuples and multiple columns. The tables are typically stored on direct access storage devices (DASD), such as magnetic or optical disk drives for semi-permanent storage.

Tables in the database are searched using, for example, a Structured Query Language (SQL), which specifies search operations or predicates to perform on columns of tables in the database to qualify rows in the database tables that satisfy the search conditions. Relational DataBase Management System (RDBMS) software using a Structured Query Language (SQL) interface is well known in the art. The SQL interface has evolved into a standard language for RDBMS software and has been adopted as such by both the American National Standards Institute (ANSI) and the International Standards Organization (ISO).

Indexes are used with database implementations in order to provide good application query performance. An index may be described as a set of pointers that are logically ordered by the values of a key (i.e., a column or collection of columns in a table). Indexes provide quick access to data and can enforce uniqueness on the rows in the table. The definition and exploitation of appropriate indexes facilitates quick identification of a candidate subset of rows in a Relational Database Management System (RDBMS).

Indexes are typically constructed using the data values in one or more columns of an RDBMS table row (e.g., using information such as product number, customer name, address, etc.). This information is represented by bit strings that define numeric or character values. An RDBMS may implement a B-tree index, which creates a binary tree based on the bit string values. When a query includes values of columns contained in an index, the B-tree index can be scanned quickly to find the candidate rows with these column values.

Complex datatypes, such as spatial or image data can also be stored as values in table columns, but the binary representation of this data is not directly usable in the creation of a B-tree index. Spatial data typically consists of point, line, and polygon geometries, which are represented by one or more coordinates consisting of pairs of numeric values (x,y) corresponding to locations on the earth. Queries against spatial or image data typically are more complex than identifying a specific row or a set of rows with values between a simple range.

DB2® Spatial Extender, available from International Business Machines Corporation, allows storage, management, and analysis of spatial data (information about the location of geographic features) in DB2® Universal Database™ (UDB), along with traditional data for text and numbers. DB2® Spatial Extender has implemented a grid spatial index on top of a B-tree index using object-relational capabilities. At runtime, queries generate start/stop key ranges (i.e., “search ranges”), which are composed of multiple fields. Then, an index scan is performed with the intention of scanning a small “rectangular” region of a B-tree index. Unfortunately, a much larger region is scanned than is desired. This results in a potentially large number of index page fetches from a Direct Access Storage Device (DASD), with corresponding negative impact on performance, especially in a multi-user environment.

Therefore, there is a continued need in the art to improve indexing.

### SUMMARY OF THE INVENTION

Provided are an article of manufacture, system, and method for index exploitation. A spatial region query referencing a spatial region is received. The spatial region is divided into intervals. Search ranges are generated for each interval. An index scan is performed for each interval.

### BRIEF DESCRIPTION OF THE DRAWINGS

Referring now to the drawings in which like reference numbers represent corresponding parts throughout:

FIG. 1 illustrates, in a block diagram, a computing environment in accordance with certain implementations.

FIG. 2 illustrates a compiler in accordance with certain implementations.

FIG. 3 illustrates a grid (represented by horizontal and vertical lines) that overlays a portion of a map of the United States and that may be used as the basis for a grid index in accordance with certain implementations.

FIG. 4 illustrates in more detail a region south of Chicago, Ill. in accordance with certain implementations.

FIG. 5 illustrates a region with grid cells that intersect a query window in accordance with certain implementations.

FIG. 6 illustrates a region with grid cells that intersect another query window in accordance with certain implementations.

FIGS. 7 and 8 illustrate regions with grid cells that would actually be referenced as a result of a region technique B-tree index scan with the specified start and stop values.

FIGS. 9A and 9B illustrate logic for performing an interval technique and limiting the index scan in accordance with certain implementations.

FIG. 10 illustrates a region with actual grid cells referenced with the indicated start and stop values in accordance with certain implementations.

FIG. 11 illustrates logic for determining whether to use a region technique or an interval technique.

FIG. 12 illustrates an architecture of a computer system that may be used in accordance with certain implementations.

### DETAILED DESCRIPTION OF THE IMPLEMENTATIONS

In the following description, reference is made to the accompanying drawings which form a part hereof and which illustrate several implementations of the invention. It is understood that other implementations may be utilized and structural and operational changes may be made without departing from the scope of implementations of the invention.

In certain implementations, a minimal region of an index (e.g., a B-tree index) is scanned by breaking up a region of spatial data into a set of “intervals.” Then, an index scan is performed for each interval. The multiple scans of intervals reduce the values of the index that are actually scanned. Although examples herein may refer to B-tree indexes for ease of illustration, implementations of the invention are applicable to other indexes that are similar to a B-tree index in terms of a linear ordering of compound key fields that may be searched with a linear range. Also, the technique of dividing a region into intervals and generating search ranges for each interval will be referred to herein as an “interval technique” for ease of reference. In certain implementations, a single search range for a region is generated, and this technique will be referred to as the “region” technique for ease of reference.

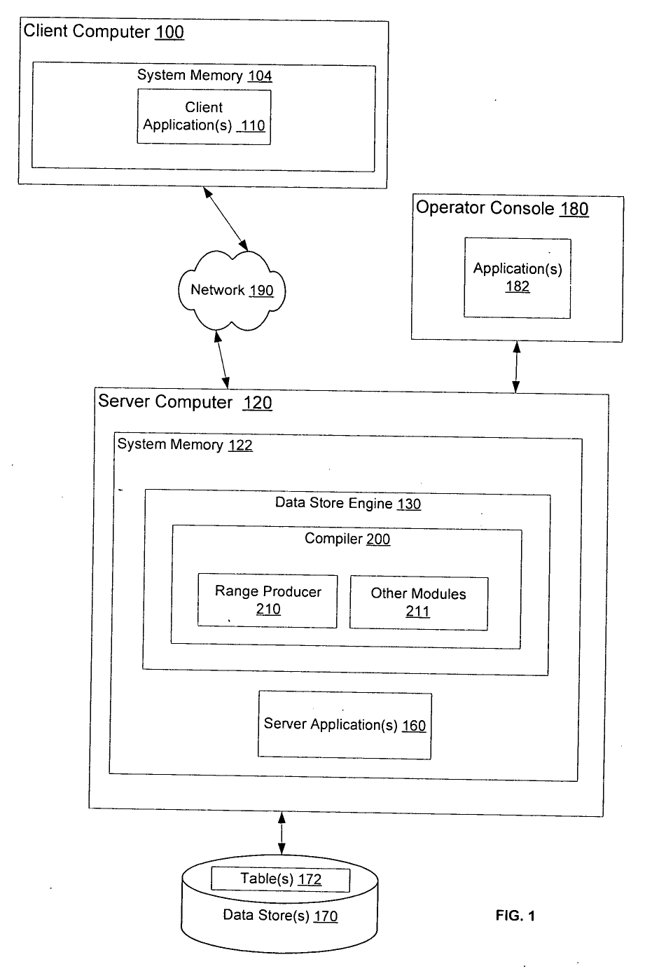

FIG. 1 illustrates, in a block diagram, a computing environment in accordance with certain implementations. A client computer 100 is connected via a network 190 to a server computer 120. The client computer 100 may comprise any computing device known in the art, such as a server, mainframe, workstation, personal computer, hand held computer, laptop telephony device, network appliance, etc. The network 190 may comprise any type of network, such as, for example, a Storage Area Network (SAN), a Local Area Network (LAN), Wide Area Network (WAN), the Internet, an Intranet, etc. The client computer 100 includes system memory 104, which may be implemented in volatile and/or non-volatile devices. One or more client applications 110 may execute in the system memory 104.

The server computer 120 includes system memory 122, which may be implemented in volatile and/or non-volatile devices. A data store engine 130 executes in the system memory 122 to store, manage, and analyze data in one or more data stores 170. The data store engine 130 contains several submodules (not shown), including a Relational Database System (RDS), a Data Manager, a Buffer Manager, and other components that support the functions of the SQL language, i.e. definition, access control, interpretation, compilation, database retrieval, and update of user and system data. The data store engine 130 also includes a compiler/interpreter 200, which includes a range-producer module 210 and other modules 211. In certain implementations, the range-producer module 210 generates a search range for each interval of a spatial region (e.g., a rectangle, circle or polygon). Additionally, one or more server applications 160 may execute in system memory 122.

The server computer 120 provides the client computer 100 with access to data in one or more data stores 170 (e.g., databases). For example, a client application 110 may submit a SQL query to the data store engine 130 to access data in a data store 170. Tables 172 and other data in data stores 170 may be stored in data stores at other computers connected to server computer 120. Also, an operator console 180 executes one or more applications 182 and is used to access the server computer 120 and the data stores 170. Although tables 172 are referred to herein for ease of understanding, other types of structures may be used to hold the data that is described as being stored in tables 172.

The data stores 170 may comprise an array of storage devices, such as Direct Access Storage Devices (DASDs), Just a Bunch of Disks (JBOD), Redundant Array of Independent Disks (RAID), virtualization device, etc.

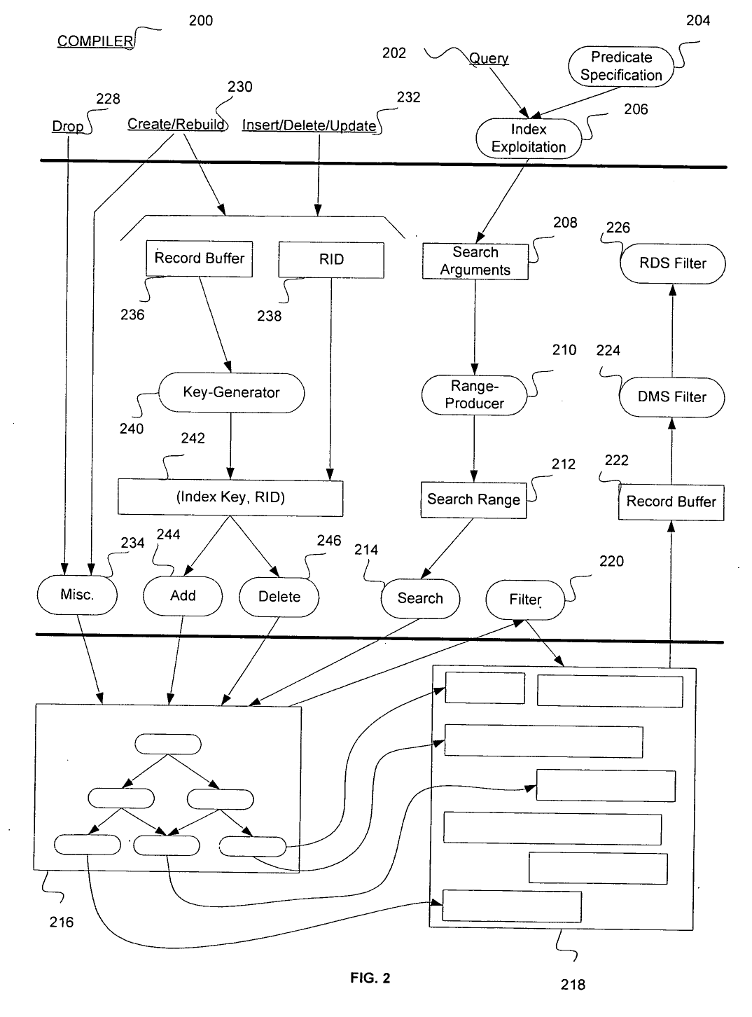

FIG. 2 illustrates a compiler 200 in accordance with certain implementations. When a query is submitted to the data store engine 130, the complier 200 interprets the query and performs optimization. Additionally, the compiler generates an application plan. An application plan may be described as a set of run-time structures that considers both the available access paths (indexes, sequential reads, etc.) and system held statistics on the data to be accessed (the size of the table, the number of distinct values in a particular column, etc.), to choose what it considers to be an efficient access path for the query. Execution of the application plan outputs a result set that is returned in response to the query.

The compiler 200 contains the following “extended” modules: predicate specification module 204 and index exploitation module 206. Run-time phase includes the following “extended” modules: range-producer module 210, DMS filter module 224, RDS filter module 226, and key generator module 240. These “extended” modules provide the capability for pushing user-defined types, index maintenance and index exploitation, and user-defined functions and predicates inside the database.

The predicate specification module 204 handles user-defined predicates. The index exploitation module 206 exploits user-defined indexes. The range-producer module 210 handles user-defined search ranges, and, in particular, determines search ranges for predicates with user-defined functions and user-defined types. The range-producer module 210 has been extended to divide a region of a B-tree index into intervals and to generate search ranges for each interval, so that an index scan may be performed for each interval independently, in certain implementations. The technique of dividing a region into intervals and generating search ranges for each interval will be referred to herein as an “interval technique” for ease of reference. In certain implementations, the range-producer module 210 does not divide a region into intervals, but generates a single search range for the region, and this technique will be referred to as the “region” technique for ease of reference. The DMS filter module 224 and the RDS filter module 226 handle user-defined functions for filtering data.

Additionally, the predicate specification module 204, the index exploitation module 206, and the DMS filter module 224 work together to evaluate user-defined predicates using a three-stage technique. In the first stage, an index is applied to retrieve a subset of records using the following modules: search arguments module 208, range-producer module 210, search module 214, and filter module 220. For the records retrieved, in the second stage, an approximation of the original predicate is evaluated by applying a user-defined “approximation” function to obtain a smaller subset of records, which occurs in the DMS filter module 224. In the third stage, the predicate itself is evaluated to determine whether the smaller subset of records satisfies the original predicate.

To process a query 202, the compiler 200 receives the query 202. The query 202 and the predicate specification from the predicate specification module 204 are submitted to the index exploitation module 206. The index exploitation module 206 performs some processing to exploit indexes. At run-time, the search arguments module 208 evaluates the search argument that will be used by the range-producer module 210 to produce search ranges. The range-producer module 210 will generate search ranges based on user-defined functions. The search range 212 is the output of the range-producer module 210. The search module 214 will perform a search using the B-Tree 216 to obtain the record identifier (ID) for data stored in the data storage device 218. The retrieved index key is submitted to the filter module 220, which eliminates non-relevant records. Data is then fetched into the record buffer module 222 for storage. The DMS filter module 224 and the RDS filter module 226 perform final filtering.

The key-generator module 240 has been modified to enable users to provide user-defined functions for processing inputs to produce a set of index keys. The user-defined functions can be scalar functions or table functions. A scalar function generates multiple key parts to be concatenated into an index key. A table function generates multiple sets of key parts, each of which is to be concatenated into an index key. Additionally, the input to the key-generator module 240 can include multiple values (e.g., values from multiple columns or multiple attributes of a structured type), and the user-defined functions can produce one or more index keys.

The compiler 200 can process various statements, including a Drop 228, Create/Rebuild 230, or Insert/Delete/Update 232 statements. A Drop statement 228 may be handled by miscellaneous modules 234 that work with the B-Tree 216 to drop data.

An Insert/Delete/Update statement 232 produce record data in the record buffer module 236 and the RID module 238. The data in the record buffer module 236 is submitted to the key-generator module 240, which identifies key sources in the records it receives. Key targets from the key-generator module 240 and record identifiers from the RID module 238 are used by the index key/RID module 242 to generate an index entry for the underlying record. Then, the information is passed to the appropriate module for processing, for example, an add module 244 or a delete module 246.

The compiler 200 will process a Create/Rebuild statement 230 in the manner of the processing a Drop statement 228 when data is not in the table or an Insert/Delete/Update statement 232 when data is in the table.

Implementations of the invention provide object-relational capabilities to define an “extended index” on User-Defined Structured Types (UDST), which are used to implement spatial datatypes. The two main components of this are provided through a “key-generator” module 240 and a range-producer module 210.

When a UDST value is inserted or updated in a column which has an extended index defined on it, the key-generator module 240 is passed the UDST value. The key-generator module 240 can then return one or more sets of alpha-numeric values which will be stored using the B-tree mechanism.

When a point, line or polygon geometry value is inserted or updated, the key-generator module 240 is invoked to determine which grid cells intersect the geometry value and to return the (gridX, gridY) values of these grid cells. The (gridX, gridY) values are then stored in the B-tree index. In certain implementations, additional values may also be stored as part of the index key in order to assist in the processing of filter module 220. These additional values may be returned for keys that satisfy the (gridX, gridY) search range, although the additional values may not be used during index scan.

When a query is performed against a column containing UDST values and on which an extended index is defined, the values in the query are passed to the range-producer module 210. The range-producer module 210 returns a search range formed by a set of start-key and stop-key values. The search module 214 scans and returns the row identifiers (RID) of all rows which have key values between the start-key and stop-key values.

To provide a better understanding of the invention, an example will be described to illustrate use of an index scan. The example will be provided based on representing and querying US highways that are represented as line geometries.

When dealing with spatial data, a “spatial region query” may be submitted. A spatial region query may be described as a query that defines a spatial region (e.g., a rectangle, circle or polygon) and seeks to find rows containing geometries that are within or that intersect the spatial region. A spatial region query may be issued by an application program to draw map data on, for example, a computer screen. As an example, a spatial region query may be issued to find all rivers in a polygon representing the state of California. In this case, the minimum bounding rectangle (MBR) of the California polygon is used to define the spatial region coordinates that are provided as input to the range-producer module 210. In certain implementations, the DMS filter 224 and/or the RDS filter 426 perform additional detailed analysis to compare the California polygon with candidate river geometries returned by the index scan and filter module 220.

One example of a spatial region query is a window query. The window query may be described as defining a rectangular coordinate region and seeking to find rows containing geometries that are within or that intersect this rectangular coordinate region. Although examples herein may refer to window queries and/or rectangular regions for ease of understanding, implementations of the invention are applicable to various types of spatial region queries and to various spatial regions (e.g., circular, triangular, rectangular, etc.).

Although point geometries that can be specified as a single pair of (x,y) numeric values can be directly and efficiently represented by a traditional B-tree index, implementations of the invention provide a better representation.

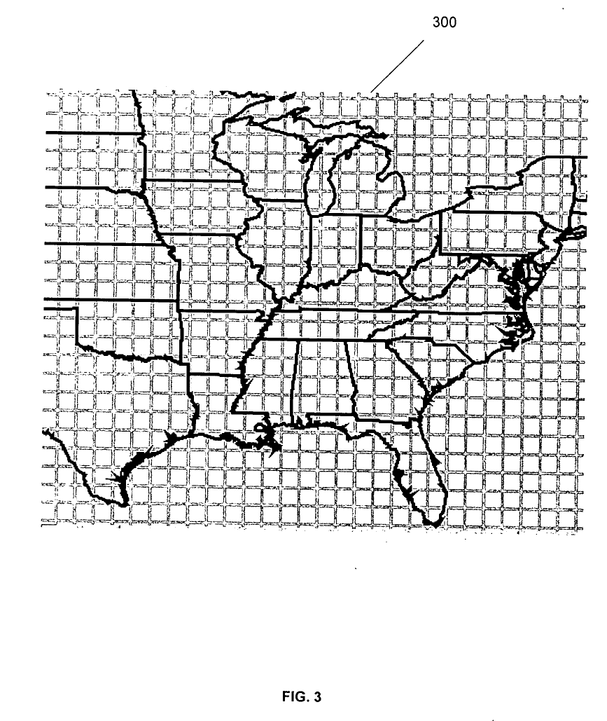

Line and polygon geometries can not be directly represented by a single pair of (x,y) numeric values, but, instead, are represented by sets of pairs of numeric values. The approach provided by a “Grid Index” logically overlays the coordinate space with a rectangular grid. FIG. 3 illustrates a grid (represented by horizontal and vertical lines) that overlays a portion of a map 300 of the United States and that may be used as the basis for a grid index in accordance with certain implementations. For this illustration, each grid cell is one degree longitude (x) by one degree latitude (y). Each of the rectangular grids can be referenced by the (x,y) value of its lower-left corner.

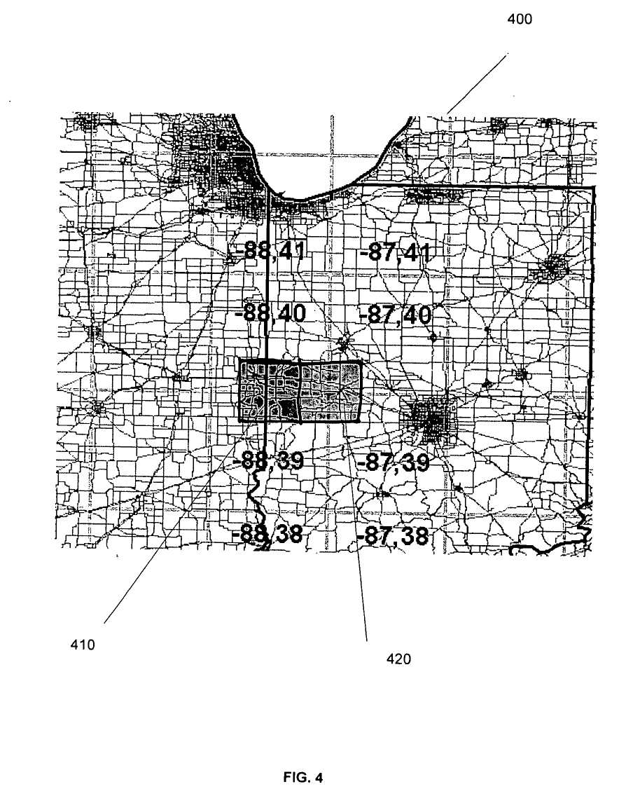

FIG. 4 illustrates in more detail a region 400 south of Chicago, Ill. in accordance with certain implementations. The bold numbers are identifying (gridX, gridY) values for some of the grid cells. Squares 410 and 420 represent two different query windows. Query windows are examples of spatial regions. When a query referencing a polygon is received, a query window in the form of a rectangle or square that covers the polygon is identified. Although examples refer to query windows, implementations of the invention are applicable to any type of spatial region.

Looking at FIG. 4, when a line geometry corresponding to a highway is inserted or updated, the key-generator module 240 computes the (gridX, gridY) values of the grid cells that intersect the highway, and these values are inserted into the B-tree index. For example, for each of the highways that intersect the grid cell identified by (−88,40), an index entry is created with the key values (−88,40) and with a row identifier (RID) of the corresponding row in the table that describes that highway.

When a spatial region query is performed that includes the specification of a query window and a spatial index is defined on a column containing spatial data values, the range-producer module 210 is passed the query window coordinates. The range-producer module 210 then returns startGridX, startGridY and stopGridX, stopGridY values for the grid cells that intersect the query window.

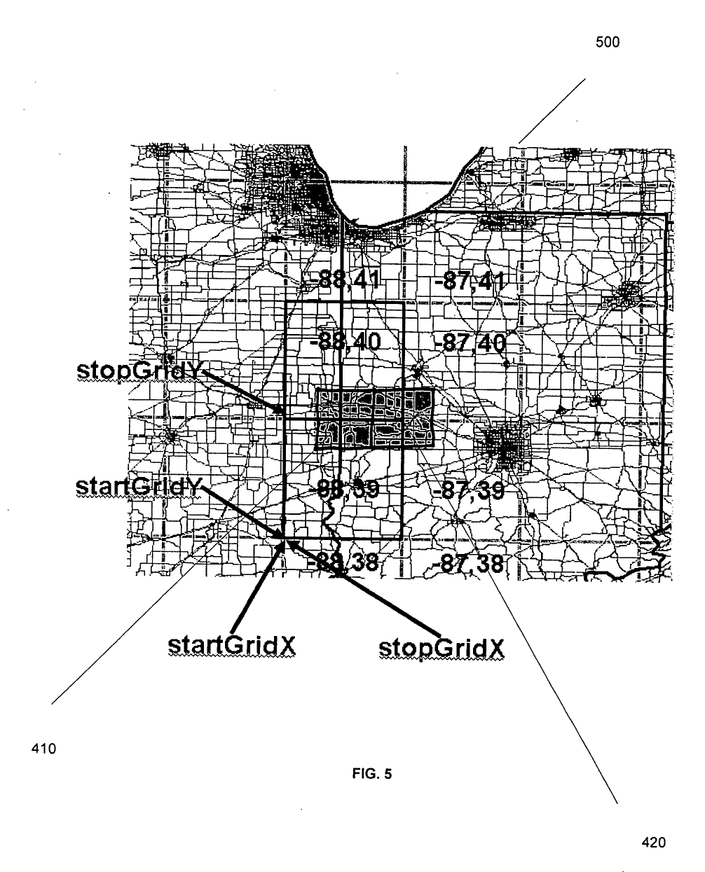

FIG. 5 illustrates a region 500 with grid cells (−88,40) and (−88,39) that intersect query window 410, which has a lower-left coordinate of (−87.75, 39.75) and an upper-right coordinate of (−87.25, 40.25) in accordance with certain implementations. The range-producer module 210 produces the start values (−88, 39) and stop values (−88, 40), which will result in the B-tree index scan for the two highlighted grid cells. This is a desired and optimal situation.

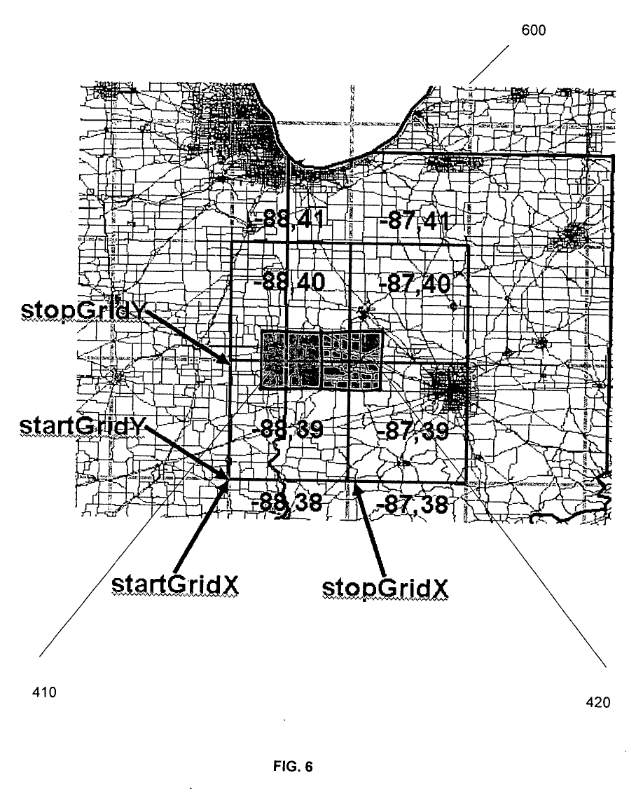

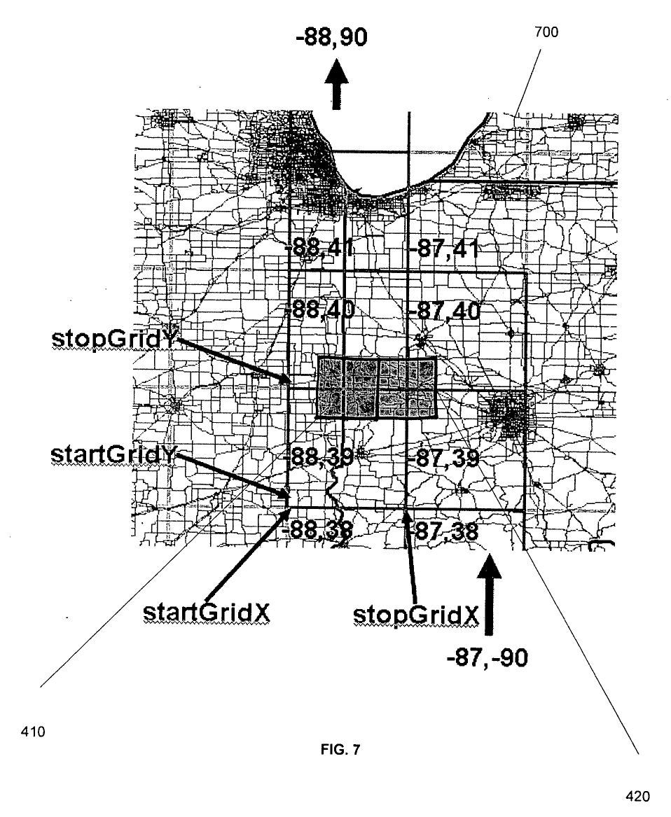

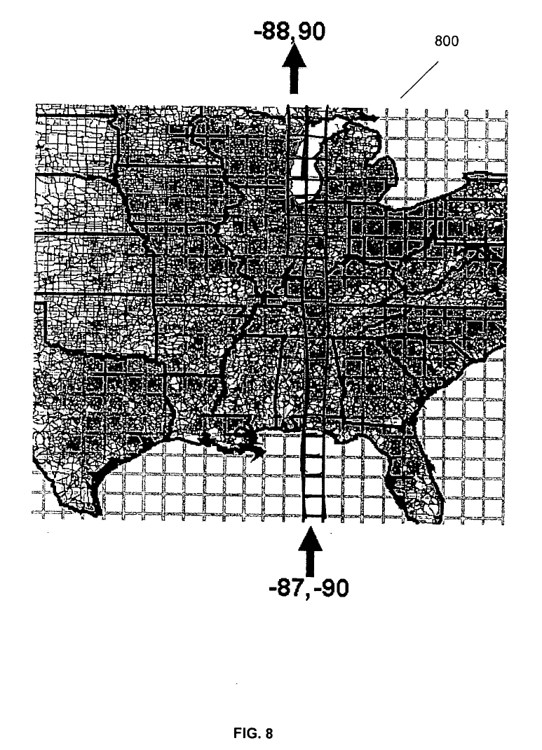

With a range-producer module 210 implementing the region technique, depending on the actual coordinates of the query window, more grid cells than are desired may be scanned. FIG. 6 illustrates a region 600 with grid cells that intersect another query window 420, with a lower-left coordinate of (−87.25, 39.75) and an upper-right coordinate of (−86.75, 40.25) in accordance with certain implementations. The intention is to reference the four grid cells (−88,40), (−88,39), (−87.40), and (-87,39) and the index entries for the corresponding highways in these four grid cells. The range-producer module 210 implementing the region technique produces the start values (−88, 39) and stop values (−87, 40). The B-tree index scan between these start and stop values references many times more grid cells, including (−88, 40), (−88, 41), . . . , (−88, gridYMax) and (−87, gridYMin), . . . , (−87, 38), (−87, 39). This effect is illustrated in FIGS. 7 and 8. With the data used in this example, 17653 index entries are actually scanned, even though there are only 4177 index entries corresponding to the four grid cells of interest. Due to subsequent filtering processes, the correct results are returned, although the query times are considerably greater.

In FIG. 6, the four grid cells that were desired were illustrated, while FIGS. 7 and 8 illustrate regions 700 and 800, respectively, with the grid cells that would actually be referenced as a result of a region technique B-tree index scan with the specified start and stop values.

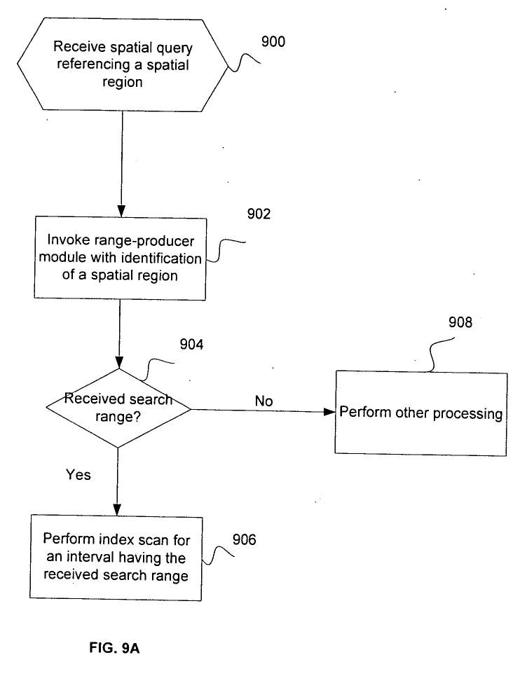

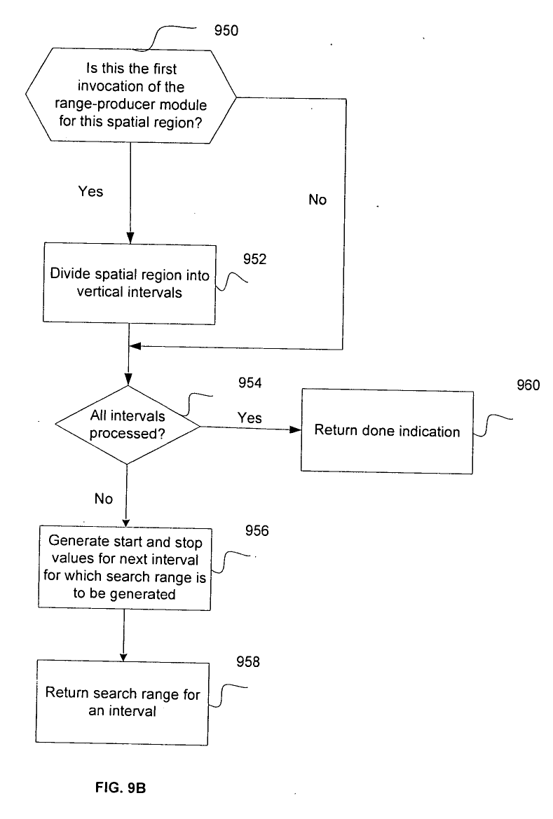

With implementations of the invention, the range-producer module 210 is modified to limit the B-tree index scan to the desired grid cells. FIGS. 9A and 9B illustrate logic for performing an interval technique and limiting the index scan in accordance with certain implementations. In FIG. 9A, control begins at block 900 with receipt by index exploitation module 206 of a spatial region query referencing a spatial region. In block 902, the index exploitation module 206 invokes the range-producer module with identification of a spatial region (e.g., a query window). In block 904, the index exploitation module 206 determines whether a search range (rather than a done indication) was received from the range-producer module 210. If so, processing continues to block 906, otherwise, processing continues to block 908. In block 906, an index scan is performed for an interval having the received search range. If the range-producer module 210 returned a done indication, then other processing may be performed in block 908.

In FIG. 9B, control begins at block 950 with the range-producer module 210 determining whether this is the first invocation of the range-producer module 210 for the specified spatial region. If so, processing continues to block 952, otherwise, processing continues to block 954. In block 952, the range-producer module 210 divides the spatial region into vertical intervals of constant gridX value. In block 954, the range-producer module 210 determines whether all intervals have been processed. If all intervals have been processed, processing continues to block 956, otherwise, processing continues to block 958. In block 956, the range-producer module 210 returns a done indication. In block 958, the range-producer module 210 returns start and stop values for the next interval for which a search range is to be generated (i.e., starting with the first interval the first time the range-producer module 210 is invoked, with the second interval the second time the range-producer module 210 is invoked, etc.). In block 960, the range-producer module 210 returns a search range for an interval. In certain implementations, the search range defines a rectangular region. For example, the range-producer module 210 returns start values of (currentGridX, startGridY) and stop values of (currentGridX, stopGridY), where currentGridX varies between startGridX and stopGridY in increments of the grid size for each interval.

In certain implementations, the range-producer module 210 is invoked until the range-producer module 210 returns a done indication (i.e., an indication that it is “done” returning search ranges for intervals for this spatial region), and with each invocation, the range-producer module 210 returns a start/stop range for one interval. In certain implementations, as part of index exploitation module 206, the range-producer module 210 is called one or more times until the range-producer module 210 indicates that it is done. For each time that the range-producer module 210 is called, modules 212, 214, 216, and 220 are called. At the end, the record buffer 422 is passed back to the DMS/RDS filters 224, 226. In block 906, an index scan is performed for each interval.

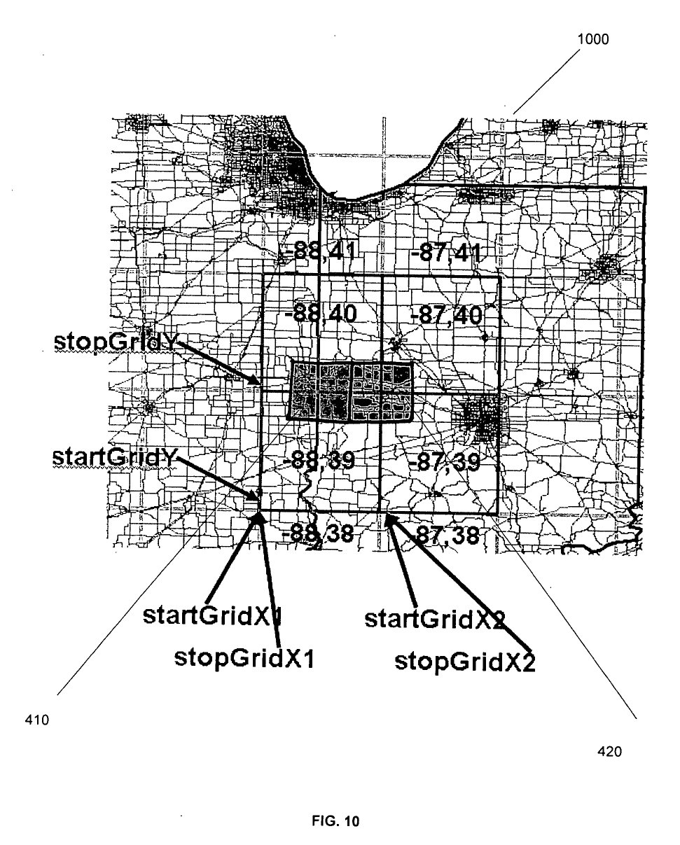

FIG. 10 illustrates a region 1000 with actual grid cells referenced with the indicated start and stop values in accordance with certain implementations. With the interval technique, 4177 index entries are scanned, compared with 17653 index entries under the region technique. Typical queries have a factor of 10 to 100 difference in the number of index entries scanned between the interval technique and the region technique.

Customer testing with the region technique resulted in query times of 5 to 50 seconds. With the interval technique, the query times were more predictable and in the range of 5 to 10 seconds.

The following Statement (1) is a sample pseudocode statement that may be submitted to create a user-defined index type for a grid index by using “CREATE INDEX EXTENSION” in accordance with certain implementations:

Statement (1)

CREATE INDEX EXTENSION grid_index (

gridSize DOUBLE)

-- index maintenance
FROM SOURCE KEY ( geometry ST_Geometry )

GENERATE KEY USING GseGridIdxKeyGen (

geometry..xMin, geometry..xMax,
geometry..yMin, geometry..yMax,
gridSize)

WITH TARGET KEY

gridX INTEGER, gridY INTEGER,
xMin DOUBLE, xMax DOUBLE,
yMin DOUBLE, yMax DOUBLE )

-- index search

SEARCH METHODS

WHEN window(wxmn double,wymn
double,wxmx double, wymx double)
RANGE THROUGH GridRangeProducer(

wxmn,wxmx,
wymn,wymx,
gridSize)

FILTER USING

CASE WHEN

(wymn > ymax) OR
(wymx < ymin) OR
(wxmn > xmax) OR
(wxmx < xmin)

THEN 0
ELSE 1

END

In Statement(1), the CREATE INDEX EXTENSION “grid_index” statement creates an index type. The name of the index type being created is “grid_index”. The index type “grid_index” takes a value for “gridSize” as input when an index instance of “grid_index” is created. The FROM SOURCE KEY (geometry ST_Geometry) statement generates keys to be stored into a B-tree index when data is added to a table corresponding to the B-tree index. The keys are generated using the GseGridIdxKeyGen (geometry.xMin, geometry.xMax, geometry.yMin, geometry.yMax, gridSize) function, which is one implementation of a key-generator module 240. The WITH TARGET KEY statement specifies the values returned by the key-generator module 240 and which are stored as part of an index key.

The statement “SEARCH METHODS” defines the search methods to be used for the index of type “grid_index”. The “WHEN window” statement under the “SEARCH METHODS” statement identifies a search method for a window query for which a search range is found by invoking a GridRangeProducer (wxmn, wxmx, wymn, wymx, gridsize) function, which is one implementation of a range-producer module. The FILTER USING statement performs filtering of index entries that are retrieved by comparing the retrieved values to the query window defined by the WHEN window statement.

The following Statement (2) is a sample definition for a GridRangeProducer(xMin DOUBLE, xMax DOUBLE, yMin DOUBLE, yMax DOUBLE, gridSize) function in accordance with certain implementations:

Statement (2)

CREATE FUNCTION GridRangeProducer (

xMin DOUBLE, xMax DOUBLE,
yMin DOUBLE, yMax DOUBLE,
gridSize)

RETURNS TABLE (

xStart INTEGER, yStart INTEGER,
xStop INTEGER, yStop INTEGER)

EXTERNAL NAME
‘gsefn!gseGridIndexRangeProducer’
LANGUAGE C

In Statement(2), the CREATE FUNCTION statement creates a user-defined function “GridRangeProducer” with arguments xMin DOUBLE, xMax DOUBLE, yMin DOUBLE, yMax DOUBLE, and gridSize. The GridRangeProducer( ) function returns a row of a table with start/stop B-tree index key search ranges for the grid cells that overlap the input query window. The first time the GridRangeProducer( ) function is called within grid_index, the GridRangeProducer( ) function generates a number of intervals. Then, the GridRangeProducer( ) function is called until the GridRangeProducer( ) function returns a done indication. For each call, the GridRangeProducer( ) function maintains an indication of which intervals have been processed so far and processes the next interval, until all intervals are processed. Then, the GridRangeProducer( ) function returns a done indication. The RETURNS TABLE (xStart INTEGER, yStart INTEGER, xStop INTEGER, yStop INTEGER) statement indicates that a row of a table is returned with four values represent the search range for an interval. In alternative implementations, the GridRangeProducer( ) function also determines whether or not to generate intervals (i.e., whether to implement the interval technique or the region technique).

The following Statement (3) is sample pseudocode for the EnvelopesIntersect( ) function in accordance with certain implementations:

Statement (3)

CREATE FUNCTION EnvelopesIntersect (

geometry1 ST_Geometry,
xmin double, ymin double,

xmax double, ymax double)

RETURNS INTEGER
LANGUAGE SQL
PREDICATES (

| WHEN = 1 | |
|---|---|
| SEARCH BY | INDEX EXTENSION grid_index |

WHEN KEY (geometry1)
USE window(xmin, ymin,

xmax, ymax)

)

RETURN 1

In Statement(3), the CREATE FUNCTION statement creates a user-defined function “EnvelopesIntersect” with arguments geometry1 ST_Geometry, xmin double, ymin double, xmax double, and ymax double. The EnvelopesIntersect( ) function performs a search using a grid_index index.

The following Statement (4) is a sample pseudocode statement that may be submitted to retrieve a highway name having a shape from a highways table where a window defined by (−87.25, 39.75, −86.75, 40.25) intersects the shape in accordance with certain implementations:

Statement (4)

SELECT

hwyname,
shape

FROM

highways

WHERE

EnvelopesIntersect(shape, −87.25, 39.75, −86.75, 40.25) = 1

The SELECT statement includes a predicate referencing the EnvelopesIntersect( ) function, which uses the grid_index, which in turn invokes the GridRangeProducer( ) function.

In certain implementations of the interval technique, in a parallel computing environment, each of the intervals are scanned at the same time, substantially reducing the elapsed time to perform the total index scan.

Certain implementations of the interval technique are oriented towards a compound index of gridX, gridY values that are integer-valued and not continuous (e.g., floating point or real). However, implementations of the interval technique are also applicable to other situations in which a compound index is composed of discrete values (e.g., character values).

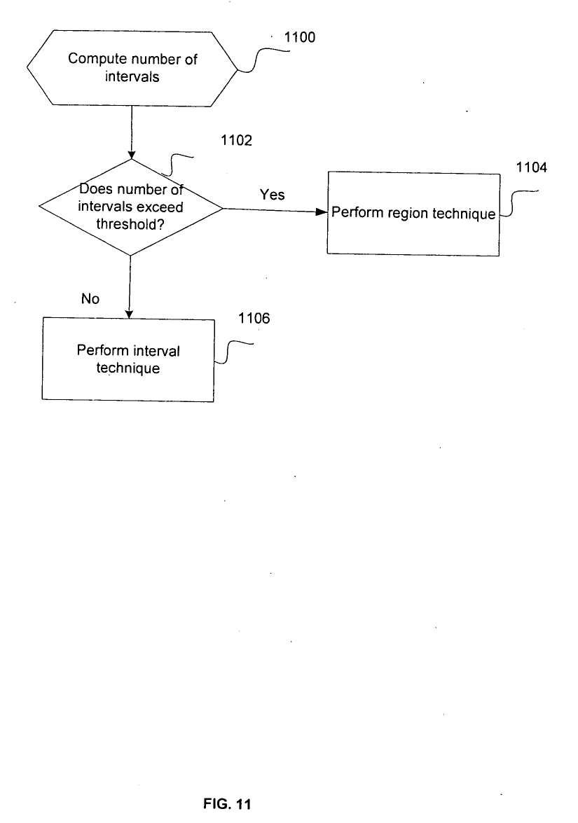

FIG. 11 illustrates logic for determining whether to use a region technique or an interval technique. One factor to consider is the possible increase in time for performing index scans if too many intervals are generated, as each one causes a restart of the B-tree index scan. Control begins at block 1100 with the range-producer module 210 determining the number of intervals. In certain implementations, the number of intervals is an estimated value. In certain implementations, the number of intervals may be computed with equation (1), where stopGridX and startGridX are the query window limits:
numIntervals=(1+stopGridX−startGridX) Equation (1)

In block 1102, the range-producer function determines whether the number of intervals exceeds a threshold. In block 1102, if the number of intervals exceeds the threshold, processing continues to block 1104, otherwise, processing continues to block 1106. In block 1104, the range-producer module 210 performs the region technique. In block 1106, the range-producer module 210 performs the interval technique.

Thus, in certain implementations, a threshold for the number of intervals is set, which, if exceeded, results in the original single set of start and stop values being generated by the range-producer module 210. Although it is difficult to determine an optimal threshold in advance, testing has indicated that a value of 1000 is not excessive and most typical spatial queries result in the generation of only 1 to 10 intervals.

The relative times to perform the index scan for the region technique (t1) may be approximated using equation (2) and for the interval technique (t2) may be approximated using equation (3):
t1=i0+i1*n*numIntervals/(1+maxGridX−minGridX) Equation (2)

In equation (2), i0 is the overhead to initiate a B-tree index scan, i1 is the cost to process each index entry scanned, n is the total number of index entries, numIntervals is the “width” of the query window, and (1+maxGridX−minGridX) is the “width” of the entire data extent.
t2=i0*numIntervals+i1*n*numIntervals*(1+stopGridY−startGridY)/((1+maxGridX−minGridX)*(1+maxGridY−minGridY)) Equation (3)

In equation (3), (1+stopGridY−startGridY) is the “height” of the query window, and (1+maxGridY−minGridY) is the “height” of the entire data extent. Typically i0 is very small and numIntervals is also small compared with n, which may be upwards of 1 million in reasonable size tables. Equation (4) results if the i0 terms are dropped:
t1/t2=(1+maxGridY−minGridY)/(1+stopGridY−startGridY) Equation (4)

Typically, the ratio of equation (4) is on the order of 10 to 1 or 100 to 1 or greater, an indication of the advantage of the interval technique over the region technique in certain implementations.

IBM and DB2 are registered trademarks or common law marks of International Business Machines Corporation in the United States and/or other countries.

### Additional Implementation Details

The described techniques for implementations of the invention may be implemented as a method, apparatus or article of manufacture using standard programming and/or engineering techniques to produce software, firmware, hardware, or any combination thereof. The term “article of manufacture” as used herein refers to code or logic implemented in hardware logic (e.g., an integrated circuit chip, Programmable Gate Array (PGA), Application Specific Integrated Circuit (ASIC), etc.) or a computer readable medium, such as magnetic storage medium (e.g., hard disk drives, floppy disks, tape, etc.), optical storage (CD-ROMs, optical disks, etc.), volatile and non-volatile memory devices (e.g., EEPROMs, ROMs, PROMs, RAMs, DRAMs, SRAMs, firmware, programmable logic, etc.). Code in the computer readable medium is accessed and executed by a processor. The code in which various implementations are implemented may further be accessible through a transmission media or from a file server over a network. In such cases, the article of manufacture in which the code is implemented may comprise a transmission media, such as a network transmission line, wireless transmission media, signals propagating through space, radio waves, infrared signals, etc. Thus, the “article of manufacture” may comprise the medium in which the code is embodied. Additionally, the “article of manufacture” may comprise a combination of hardware and software components in which the code is embodied, processed, and executed. Of course, those skilled in the art will recognize that many modifications may be made to this configuration without departing from the scope of the implementations of the invention, and that the article of manufacture may comprise any information bearing medium known in the art.

The logic of FIGS. 9 and 11 describes specific operations occurring in a particular order. In alternative implementations, certain of the logic operations may be performed in a different order, modified or removed. Moreover, operations may be added to the above described logic and still conform to the described implementations. Further, operations described herein may occur sequentially or certain operations may be processed in parallel, or operations described as performed by a single process may be performed by distributed processes.

The illustrated logic of FIGS. 9A, 9B, and 11 may be implemented in software, hardware, programmable and non-programmable gate array logic or in some combination of hardware, software, or gate array logic.

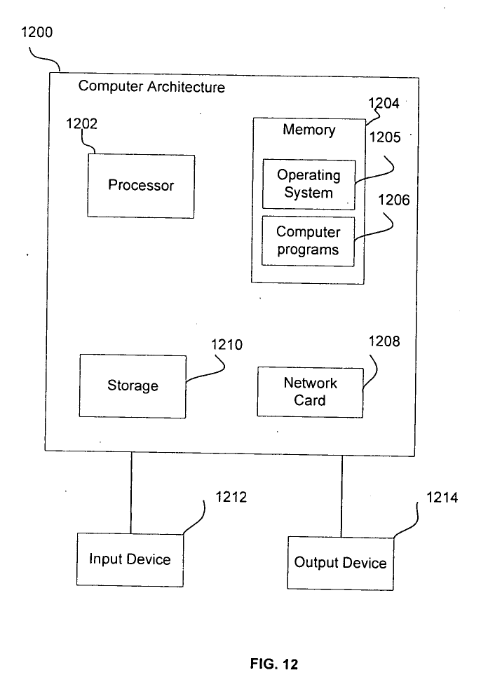

FIG. 12 illustrates an architecture 1200 of a computer system that may be used in accordance with certain implementations. Client computer 100, server computer 120, and/or operator console 180 may implement architecture 1200. The computer architecture 1200 may implement a processor 1202 (e.g., a microprocessor), a memory 1204 (e.g., a volatile memory device), and storage 1210 (e.g., a non-volatile storage area, such as magnetic disk drives, optical disk drives, a tape drive, etc.). An operating system 1205 may execute in memory 1204. The storage 1210 may comprise an internal storage device or an attached or network accessible storage. Computer programs 1206 in storage 1210 may be loaded into the memory 1204 and executed by the processor 1202 in a manner known in the art. The architecture further includes a network card 1208 to enable communication with a network. An input device 1212 is used to provide user input to the processor 1202, and may include a keyboard, mouse, pen-stylus, microphone, touch sensitive display screen, or any other activation or input mechanism known in the art. An output device 1214 is capable of rendering information from the processor 1202, or other component, such as a display monitor, printer, storage, etc. The computer architecture 1200 of the computer systems may include fewer components than illustrated, additional components not illustrated herein, or some combination of the components illustrated and additional components.

The computer architecture 1200 may comprise any computing device known in the art, such as a mainframe, server, personal computer, workstation, laptop, handheld computer, telephony device, network appliance, virtualization device, storage controller, etc. Any processor 1202 and operating system 1205 known in the art may be used.

The foregoing description of implementations of the invention has been presented for the purposes of illustration and description. It is not intended to be exhaustive or to limit the implementations of the invention to the precise form disclosed. Many modifications and variations are possible in light of the above teaching. It is intended that the scope of the implementations of the invention be limited not by this detailed description, but rather by the claims appended hereto. The above specification, examples and data provide a complete description of the manufacture and use of the composition of the implementations of the invention. Since many implementations of the invention can be made without departing from the spirit and scope of the implementations of the invention, the implementations of the invention reside in the claims hereinafter appended or any subsequently-filed claims, and their equivalents.

1. A method for index exploitation, comprising:
receiving a spatial region query referencing a spatial region;
dividing the spatial region into intervals;
generating search ranges for each interval; and
performing an index scan for each interval.

2. The method of claim 1, wherein a range-producer module is invoked one or more times to obtain a search range for each interval until the range-producer module returns a done indication.

3. The method of claim 2, wherein the range-producer module divides the spatial region into a number of intervals a first time that the range-producer module is invoked for the spatial region.

4. The method of claim 1, further comprising:
receiving the spatial region query at an index exploitation module; and
invoking, with the index exploitation module, a range-producer module, wherein the invocation identifies the spatial region, wherein the range-producer module is invoked one or more times until the range-producer module returns a done indication to generate the search ranges for each interval.

5. The method of claim 1, wherein each search range comprises values that define a rectangular region.

6. The method of claim 1, wherein the index scan is a B-tree index scan.

7. The method of claim 1, further comprising:
performing the index scan for each interval in parallel.

8. The method of claim 1, further comprising:
determining a number of intervals that the spatial region is to be divided into.

9. The method of claim 8, further comprising:
when the determined number of intervals exceeds a threshold,
generating a single search range for the spatial region; and
performing a single index scan for the spatial region using the search range.

10. The method of claim 1, wherein the spatial region query comprises a window query.

11. An article of manufacture including a program for index exploitation, wherein the program causes operations to be performed, the operations comprising:
receiving a spatial region query referencing a spatial region;
dividing the spatial region into intervals;
generating search ranges for each interval; and
performing an index scan for each interval.

12. The article of manufacture of claim 1 1, wherein a range-producer module is invoked one or more times to obtain a search range for each interval until the range-producer module returns a done indication.

13. The article of manufacture of claim 12, wherein the range-producer module divides the spatial region into a number of intervals a first time that the range-producer module is invoked for the spatial region.

14. The article of manufacture of claim 11, wherein the operations further comprise:
receiving the spatial region query at an index exploitation module; and
invoking, with the index exploitation module, a range-producer module, wherein the invocation identifies the spatial region, wherein the range-producer module is invoked one or more times until the range-producer module returns a done indication to generate the search ranges for each interval.

15. The article of manufacture of claim 11, wherein each search range comprises values that define a rectangular region.

16. The article of manufacture of claim 11, wherein the index scan is a B-tree index scan.

17. The article of manufacture of claim 11, wherein the operations further comprise:
performing the index scan for each interval in parallel.

18. The article of manufacture of claim 11, wherein the operations further comprise:
determining a number of intervals that the spatial region is to be divided into.

19. The article of manufacture of claim 18, wherein the operations further comprise:
when the determined number of intervals exceeds a threshold,
generating a single search range for the spatial region; and
performing a single index scan for the spatial region using the search range.

20. The computer system of claim 11, wherein the spatial region query comprises a window query.

21. A computer system having at least one program for index exploitation, comprising:
receiving a spatial region query referencing a spatial region;
dividing the spatial region into intervals;
generating search ranges for each interval; and
performing an index scan for each interval.

22. The computer system of claim 21, wherein a range-producer module is invoked one or more times to obtain a search range for each interval until the range-producer module returns a done indication.

23. The computer system of claim 22, wherein the range-producer module divides the spatial region into a number of intervals a first time that the range-producer module is invoked for the spatial region.

24. The computer system of claim 21, further comprising:
receiving the spatial region query at an index exploitation module; and
invoking, with the index exploitation module, a range-producer module, wherein the invocation identifies the spatial region, wherein the range-producer module is invoked one or more times until the range-producer module returns a done indication to generate the search ranges for each interval.

25. The computer system of claim 21, wherein each search range comprises values that define a rectangular region.

26. The computer system of claim 21, wherein the index scan is a B-tree index scan.

27. The computer system of claim 21, further comprising:
performing the index scan for each interval in parallel.

28. The computer system of claim 21, further comprising:
determining a number of intervals that the spatial region is to be divided into.

29. The computer system of claim 28, further comprising:
when the determined number of intervals exceeds a threshold,
generating a single search range for the spatial region; and
performing a single index scan for the spatial region using the search range.

30. The computer system of claim 21, wherein the spatial region query comprises a window query.
